(19) United States
(12) Patent Application Publication
(10) Pub. No.: US 2011/0271241 A1
(43) Pub. Date: Nov. 3, 2011

(54) JOINT IMPLEMENTATION OF INTELLECTUAL PROPERTIES (IPs) IN A SYSTEM-ON-A-CHIP (SOC)

(76) Inventors: Hari Krishnamoorthy, Bangalore (IN); Sreeram Chandrasekar, Bangalore (IN)

(21) Appl. No.: 13/093,451

(22) Filed: Apr. 25, 2011

(30) Foreign Application Priority Data
Apr. 29, 2010 (IN) 1209/CHE/2010

(51) Int. Cl. G06F 17/50

(52) U.S. Cl. 716/102

(57) ABSTRACT

A method includes jointly implementing a number of Intellectual Property (IP) sub-systems in a virtual design associated with one or more System-on-a-Chip(s) (SoC(s)) utilizing a design platform. Each sub-system of the number of IP sub-systems is associated with an IP configured to be a deliverable to the one or more SoC(s). The method also includes maintaining each sub-system of the number of IP sub-systems as an independent entity in the virtual design through an appropriate handling of a design closure and a timing closure. IPs associated with two or more IP sub-systems of the virtual design are related or unrelated to one another. ea

This application claims priority from Indian Provisional Application Serial No. 1209/CHE/2010 filed on Apr. 29, 2010, entitled “EFFICIENT PHYSICAL IMPLEMENTATION OF INTEGRATED SUB-SYSTEMS”, which is incorporated herein by reference in its entirety.

### FIELD OF TECHNOLOGY

Embodiments of the disclosure relate to joint implementation of Intellectual Property (IP) sub-systems, where the IPs are configured to be deliverable to one or more SoCs.

### BACKGROUND

An SoC includes multiple IPs associated with it. A physical design associated with an SoC includes multiple physical designs to implement the IPs in sub-systems. A physical design involving complexities of IPs therein are divided into the sub-systems such that the complexities are manageable. For each of the sub-system, a team of personnel is formed according to the expertise. The combined and concurrent efforts of the teams associated with all of the sub-systems results in the release of the IPs associated with the SoC. Then a test pattern is generated, following which the photo mask information created for chip fabrication is released.

In the abovementioned hierarchical design flow, the time required to implement the IPs is a function of personnel employed in each team. As it is not possible to allocate resources to cater to the peak productivity of each team, the time required for implementing the IPs and/or the computing resources required increases considerably.

### SUMMARY

In one embodiment, a method includes jointly implementing a number of IP sub-systems in a virtual design associated with one or more SoCs utilizing a design platform. Each sub-system of the number of IP sub-systems is associated with an IP configured to be a deliverable to the one or more SoCs. The method also includes maintaining the each sub-system of the number of IP sub-systems as an independent entity in the virtual design through an appropriate handling of a design closure and a timing closure. IPs associated with two or more IP sub-systems of the virtual design may be related or unrelated to one another.

In another embodiment, a method includes combining a common process involved in an individual implementation of each sub-system of a number of IP sub-systems associated with one or more SoCs to enable a joint implementation in a virtual design through a design platform. The each sub-system of the number of IP sub-systems is associated with an IP configured to be a deliverable to the one or more SoCs. The method also includes increasing an implementation capacity of personnel resource associated with the implementation of the IPs associated with the plurality of IP sub-systems through the joint implementation.

In another embodiment, an SoC includes a number of IP sub-systems having IPs associated therewith. One or more IP sub-system(s) of the number of IP sub-systems is jointly implemented in a virtual design along with one or more other IP sub-system(s) through a design platform. The one or more IP sub-system(s) is associated with an IP configured to be a deliverable to the SoC. The one or more other IP sub-system(s) is associated with an IP configured to be a deliverable to the SoC or another SoC. The one or more IP sub-system(s) is entitized at the individual sub-system level in the virtual design through an appropriate handling of a design closure and a timing closure. The IP(s) associated with the one or more IP sub-system(s) and the IP(s) associated with the one or more other IP sub-system(s) are related or unrelated to each other.

The methods and systems disclosed herein may be implemented in any means for achieving various aspects, and may be executed in a form of a machine-readable medium embodying a set of instructions that, when executed by a machine, causes the machine to perform any of the operations disclosed herein.

Other features will be apparent from the accompanying drawings and from the detailed description that follows.

### BRIEF DESCRIPTION OF THE VIEWS OF DRAWINGS

Example embodiments are illustrated by way of example and not limitation in the figures of the accompanying drawings, in which like references indicate similar elements and in which:

FIG. 1 is a schematic view of physical designs of Intellectual Property (IP) sub-systems associated with a System-on-a-Chip (SoC);

FIG. 2 is a table detailing the breakup of resources associated with the development of the IP sub-systems of FIG. 1;

FIG. 3 is a schematic view of a physical design of IP sub-systems associated with an SoC;

FIG. 4 is a flowchart detailing the operations involved in the release of IPs associated with the IP sub-systems of FIG. 3 according to an embodiment;

FIG. 5 is a table detailing the breakup of resources associated with combined IP development of the IP sub-systems of FIG. 3;

FIG. 6 is a schematic view of creation of a connectivity descriptor at a virtual design level, according to an embodiment;

FIG. 7 is a schematic view of inheriting constraints associated with the IP sub-systems of FIG. 3 at the virtual design level;

FIG. 8 is a schematic view of creation of a floor-plan at the virtual design level through a “bottom-up” approach, according to an embodiment;

FIG. 9 is a schematic view of creation of a floor-plan at the virtual design level through a “top-down” approach, according to an embodiment;

FIG. 10 is a process flow diagram detailing the operations involved in a method of entitizing the IP sub-systems of FIG. 3 in a joint implementation thereof; and

FIG. 11 is a process flow diagram detailing the operations involved in a method of reducing personnel resources through a joint implementation of the IP sub-systems of FIG. 3.

Other features of the present embodiments will be apparent from the accompanying drawings and from the detailed description that follows.

### DETAILED DESCRIPTION

Disclosed are a method, an apparatus and/or a system for joint implementation of Intellectual Property (IP) sub-systems, where the IPs are configured to be deliverable(s) to one or more SoCs. Although various embodiments have been described with reference to specific example embodiments, it will be evident that various modifications and changes can be made to these embodiments without departing from the broader spirit and scope of the various embodiments.

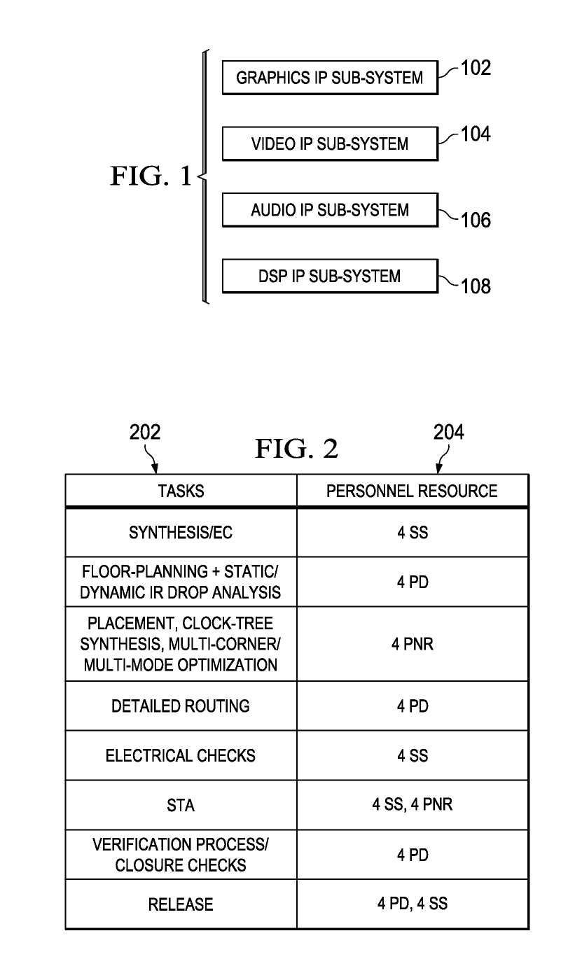

FIG. 1 illustrates individual physical designs of IP sub-systems associated with an SoC. The IP sub-systems includes a sub-system associated with graphics processing in the SoC (e.g., graphics IP sub-system 102), a sub-system associated with video processing in the SoC (e.g., video IP sub-system 104), a sub-system associated with audio processing in the SoC (e.g., audio IP sub-system 106) and a sub-system associated with Digital Signal Processing (DSP) in the SoC (e.g., DSP IP sub-system 108). The aforementioned examples of a graphics IP sub-system 102, video IP sub-system 104, an audio IP sub-system 106, and a DSP IP sub-system 108 are merely for purposes of illustration. In an embodiment, the IPs involved in the aforementioned IP sub-systems is associated with more than one SoC.

There are several use case scenarios associated with an IP sub-system, depending on the targeted SoC. In an embodiment the SoC is an integrated circuit (IC). The same IP involved in an IP sub-system is utilized in multiple ICs. Depending on the several use case scenarios, customer/user feature requests for IPs varies. This enables addition of new features to an SoC, for which a division of IPs is required. An IP is defined as a deliverable to the SoC, without which test pattern generation and the subsequent release of the photo mask information created for chip fabrication, is not possible.

With regard to FIG. 1, the IP sub-system (e.g., graphics IP sub-system 102, video IP sub-system 104, audio IP sub-system 106, DSP IP sub-system 108) development schedules are critical to the time-to-market (TTM) associated with the SoC. The timelines associated with the IPs involved therein, including bugs and architecture changes, are asynchronous to the SoC requirements. The IP implementation associated with an SoC is unique. In other words, there are several IPs/versions to implement to cater to a number of unique SoCs (e.g., Application Specific Integrated Chips (ASICs)). Multiple IP developments occur in concurrence with SoC programs. The team of personnel involved in IP development does not expand/ramp up to cater to peak productivity. Scheduling, allied with the prolificacy of requests for IPs, renders it impossible to expand the team of personnel. As it is difficult to build a team having the requisite maturity to deliver an IP, scheduling and resource allotment is not done to suit peak IP development efforts.

Thus, it is not possible to shrink the time required to implement an IP considerably. Additionally, requirements for multiple IP development may peak concurrently with the tape-out associated with an SoC, at which the artwork for the photo mask of the SoC is sent for fabrication. Therefore, computing/resource availability is a cause for concern. FIG. 2 shows a table detailing the breakup of resources associated with the development of the IP sub-systems shown in FIG. 1. Each of the IP sub-systems (viz., a graphics IP sub-system 102, video IP sub-system 104, an audio IP sub-system 106, and a DSP IP sub-system 108) requires the capability of three personnel; one for physical design (PD), where circuit elements are converted to geometrical representations, one for Place And Route (PNR), where placement of components and design of interconnects are decided, and one for Static Timing Analysis (STA)/synthesis (SS), where the expected timing of the circuit is computed and/or design implementation is realized through the appropriate logic.

The “three personnel” discussed above refers to the resources required for the realization of the aforementioned tasks, and the implementation of the IPs associated with the IP sub-systems (viz., graphics IP sub-system 102, video IP sub-system 104, audio IP sub-system 106. DSP IP sub-system 108) involves a certain amount of complexity for the abovementioned “three personnel” requirements. FIG. 2 illustrates tasks 202 associated with PD, PNR and SS and personnel resource 204 involved therein. As shown in FIG. 2, personnel resource 204 used for SS is employed in synthesis/Equivalence Checking (EC), electrical checks (e.g., through Atrenta's SpyGlass®) such as voltage/power correctness, power domain sequencing and power/ground connectivity and STA associated with a particular IP sub-system. The aforementioned SS personnel resource 204 is also employed during the release of the IP associated with the IP sub-system.

Personnel resource 204 used for PD are employed in the floor-planning of the IP sub-system includes such as, where a schematic representation of placement of the constituent functional blocks is obtained, the static/dynamic IR drop analysis is configured to enable the verification as to whether the prospective circuit handles the power supply requirements. The detailed routing associated with the IP sub-system, where actual vias and tracks for nets of the routing region are determined according to the design specification following the global routing thereof, and verification processes such as Design Rule Checks (DRCs) and/or closure checks. Again, the aforementioned PD personnel resource 204 is employed during the release of the IP associated with the IP sub-system.

Personnel resource 204 used for PNR is employed in the placement of components, as discussed above, clock tree synthesis (CTS) configured to enable development of the interconnects between the system clock and cells of the chip employing the system clock, multi-corner/multi-mode optimization configured to account for a number of mode and corner scenarios that has conflicting power, timing, and signal integrity closure requirements, and STA associated with the IP sub-system.

Assuming three compile stages associated with an IP sub-system and three months time required per compile stage as an example, the total number of man-months required to implement the four IP sub-systems (viz., graphics IP sub-system 102, video IP sub-system 104, audio IP sub-system 106, and DSP IP sub-system 108) is 4×3×3×3=108. The ‘4’ refers to the number of IP sub-systems, the first ‘3’ refers to the “three personnel” resource, the second ‘3’ refers to the number of compile stages, and the third ‘3’ refers to the time required per compile stage.

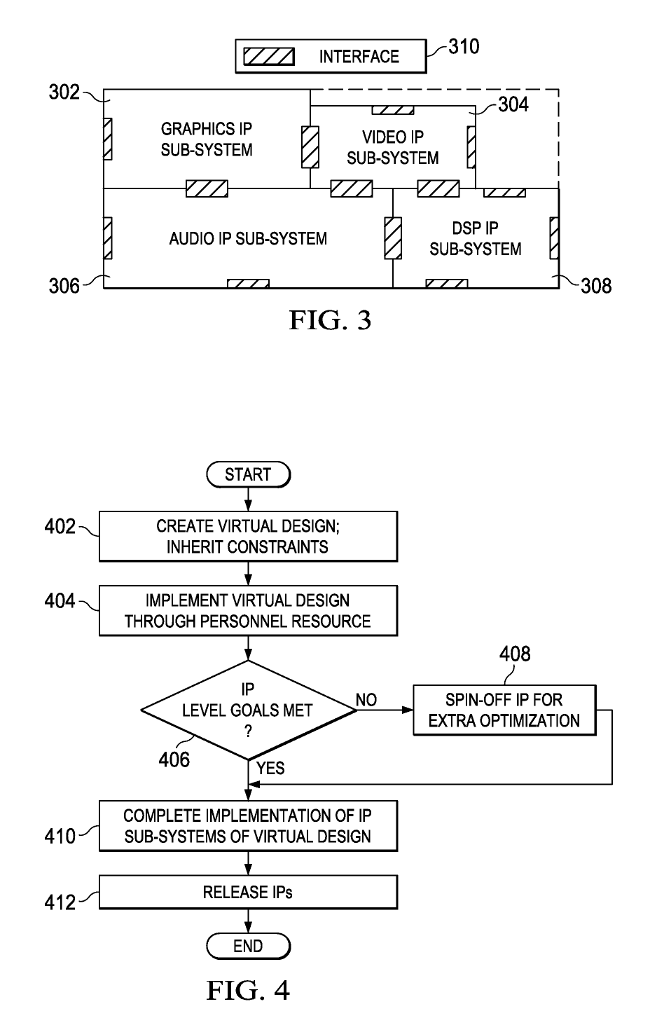

FIG. 3 illustrates a physical design of IP sub-systems associated with an SoC. The IP sub-systems, includes a sub-system associated with graphics processing in the SoC (e.g., graphics IP sub-system 302), a sub-system associated with video processing in the SoC (e.g., video IP sub-system 304), a sub-system associated with audio processing in the SoC (e.g., audio IP sub-system 306) and a sub-system associated with DSP in the SoC (e.g., DSP IP sub-system 308). It is obvious that the aforementioned examples of a graphics IP sub-system 302, video IP sub-system 304, an audio IP sub-system 306, and a DSP IP sub-system 308 are merely for purposes of illustration. Other IP sub-systems are within the scope of the exemplary embodiments.

In an embodiment, multiple designs/IPs are combined into a single implementation. Thus, in the physical design of FIG. 3, IPs associated with graphics IP sub-system 302, video IP sub-system 304, audio IP sub-system 306 and DSP IP sub-system 308 are combined to create a virtual design. In contrast to FIG. 1, in the same schedule associated with individual IPs, the combined design/virtual design encompassing all of the IP sub-systems is implemented. Realization of the combined design/virtual design includes combining common elements associated with design of the individual IP sub-systems together, utilizing the parallelization ability and the capacity of the Electronic Design Automation (EDA) tools involved, and/or enabling a “personnel” resource to work on multiple IPs together.

Multiple IPs combined in the virtual design discussed above and the designs associated therewith can be related or unrelated to one another. For example, clock frequency, area and performance goals for one IP sub-system are different from another IP sub-system. Further, no coupling and/or clock relationships are required across distinct designs of the IP sub-systems. Also, standard interface timing budgets for the IPs associated with the IP sub-systems is reused, which dispenses with the need for “in-context” budgeting (e.g., changing budgeting across individual IPs) and/or optimization across IP boundaries. Thus, iterations due to re-budgeting at various stages of the implementation are avoided. CTS and/or STA closure, for example, is not impacted.

FIG. 4 illustrates a flowchart detailing the operations involved in the release of IPs associated with the IP sub-systems of FIG. 3, where the IPs are combined to realize a virtual design. Operation 402 involves creation of a virtual design that inherits the constraints associated with the IPs of the individual IP sub-systems (viz., graphics IP sub-system 302, video IP sub-system 304, audio IP sub-system 306, and DSP IP sub-system 308). A virtual space associated with the combined design first be created, onto which the floor-plan of each IP associated with a particular IP sub-system is imported. The floor-plan is imported at the IP level. For the aforementioned purpose, each cell of the virtual design corresponds to a cell of an IP sub-system (e.g., graphics IP sub-system 302). Thus, the virtual design is in spatial correspondence with the floor-plan of the IP sub-systems and the cells.

The word “cell” used above is interpreted as a representation of logic and/or storage functions associated with an IP sub-system. For example, a “cell” is a group of transistors and interconnects that implements the logic and/or storage functions which is of a higher complexity level. In an embodiment, the initial design of a “cell” is aided through connectivity descriptors (e.g., netlists) that serve as nodal descriptions of the fundamental circuit elements associated therewith. Connectivity descriptors associated with the individual IP sub-systems is combined to realize a virtual design connectivity descriptor.

Interfaces 310 (e.g., ports) are created at the same spatial coordinates at the virtual design level as at the individual IP sub-system level. As discussed above, constraints (e.g., timing constraints) are ported to the virtual design level from the individual IP sub-system level. Operation 404 involves implementation of the virtual design through the “personnel” resource employed in the PD, PNR and SS described above. Operation 406 involves checking as to whether the IP level goals (e.g., power, performance, area, leakage) are met. In other words, checking is done to determine whether the goals associated with individual IP sub-systems are met at the virtual design level. Interfaces 310 between individual IP sub-systems translated to the virtual design space is maintained logically/physically, and with regard to the timing budgets.

For example, a “cell” associated with an IP sub-system (e.g., graphics IP sub-system 302) may not interact with a “cell” associated with another IP sub-system (e.g., video IP sub-system 304) at the virtual design level. A potential interaction between IP sub-systems (e.g., graphics IP sub-system 302 and video IP sub-system 304) is eliminated across interfaces 310 (e.g., ports). In other words, the one or more stand-alone IPs corresponding to the IP sub-systems are placed in a “bucket” to enable transportation thereof from a “soft” IP level (e.g., a Register-Transfer Level (RTL) code, where the logic/storage circuits are described through a hardware description language (HDL)) to the final layout.

If the result of operation 406 indicates that the IP level goals (e.g., power, timing, area, leakage) are not met, the IP(s) associated with the IP sub-system(s) is spun off for extra optimization in operation 408. If the goals for a single IP are not met, the corresponding IP sub-system is redone/re-optimized. If the result of operation 406 indicates that the IP level goals are met, operation 410 then involves completing the implementation associated with the appropriate IP sub-systems. The aforementioned completion includes completion of the PD/STA, the DRC sign-offs and the closure checks. The implementation of the appropriate IP sub-system(s) associated with the extra-optimized IP(s) in operation 408 is completed in operation 410.

If there are bugs associated solely with one IP sub-system, that particular IP sub-system alone is redone, and, if required, placed in the consolidated virtual design again. Operation 412 involves release of the IPs associated with the IP sub-systems. With regard to the redone IP sub-system, the implementation associated is completed in operation 410, following which the IPs associated therewith is released separately. All the IP sub-systems are placed in the same implementation vehicle but released separately. The redone IP sub-system also is placed in the same implementation vehicle, along with other IP sub-systems, for release. Here, the IPs associated with the IP sub-systems are released in a consolidated manner. However, the flexibility of the SoC is reduced, which is why the release of stand-alone IPs in operation 412 is important.

In the abovementioned combined IP implementation, common processes such as floor-planning, power routing and DRC clean-up of power grid is performed for all IP sub-systems therein. Combined optimization of parameters including but not limited to timing and congestion is done at the placement stage. The aforementioned optimization is run-time dominated, the run-time being associated with the EDA tool being used. For example, the run-time associated with the combined placement stage optimization done on video IP sub-system 304, audio IP sub-system 306 and DSP IP sub-system 308 is comparable to the run-time associated with the placement stage optimization done on video IP sub-system 104. Thus, the run-time associated with combined multiple IPs in the virtual design of FIG. 3 is comparable to the run-time associated an individual IP in the physical designs shown in FIG. 1. Verification processes such as DRC sign-off/electrical checks/other reliability checks and the fixing associated therewith are performed on the virtual design. The combined IP implementation result in lower processing (e.g., through a Central Processing Unit (CPU)) needs (e.g., during extraction, STA, DRC associated therewith).

Consolidation of the design ensures that best practices associated with IP development/implementation and/or optimization knobs are employed across multiple IPs (e.g., all IP sub-systems of FIG. 3. Design reviews/ramp reviews are common across various stages of IP maturity. For example, the various stages of IP maturity include the first compile stage, the second compile stage, and the third compile stage (in other words, the three compile stages) associated with each of the IP sub-systems of FIG. 3. Rigorous and/or high quality design reviews/ramp reviews is made possible through the combined IP implementation discussed above. The number of reviews is less compared to the IP implementation discussed with regard to FIG. 1 because of the combined IP implementation.

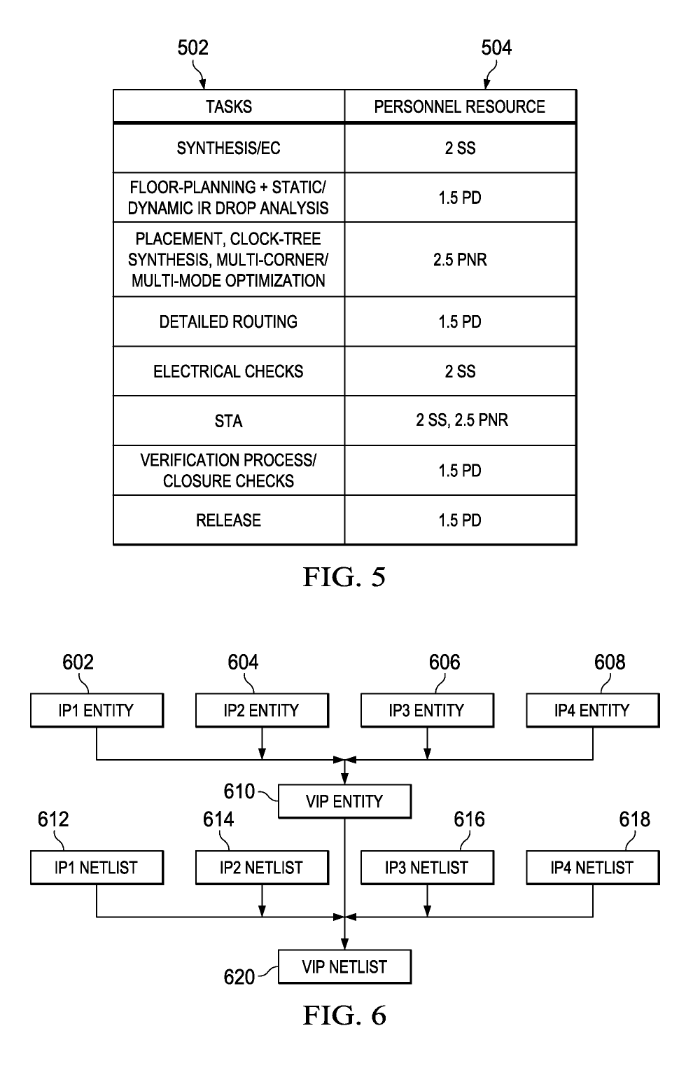

FIG. 5 illustrates a table detailing the breakup of resources associated with the combined IP development associated with the IP sub-systems shown in FIG. 3, according to an embodiment. In contrast to FIG. 1, a single team, for example, is sufficient to effect the combined IP implementation discussed above. The combined implementation of the IP sub-systems (viz., graphics IP sub-system 302, video IP sub-system 304, audio IP sub-system 306, and DSP IP sub-system 308) requires the capability of six personnel; 1.5 for PD, 2.5 for PNR and 2 for SS. The number of personnel refers to the resources required for the realization of the aforementioned tasks and that the complexity involved herein is analogous to the complexity involved in implementing the IP sub-systems of FIG. 1. In an example personnel resource allocation, the single team implementing the consolidated design includes one person for PD, two for PNR, two for SS, and one person whose work is split between PD and PNR. Variations in the resource allocation/division (number of members, teams) are within the scope of the exemplary embodiments.

FIG. 5 illustrates tasks 502 associated with PD, PNR and SS and personnel resource 504 involved therein. Again, analogous to FIG. 2, personnel resource 504 used for SS is employed in synthesis/EC, electrical checks (e.g., through Atrenta's SpyGlass®) such as voltage/power correctness, power domain sequencing and power/ground connectivity, and STA associated with the consolidated design. Again, personnel resource 504 used for PD is employed in the floor-planning of the consolidated design, where a schematic representation of placement of the constituent functional blocks thereof are obtained, the static/dynamic IR drop analysis configured to enable verifying as to whether the prospective circuit(s) handles the power supply requirements, the detailed routing associated with the consolidated design, where actual vias and tracks for nets of the routing region are determined according to the design specification following the global routing thereof, and verification processes such as DRCs and/or closure checks. Again, the aforementioned PD personnel resource 504 is employed during the release of the IPs associated with the consolidated virtual design.

Again, analogous to FIG. 2, personnel resource 504 used for PNR is employed in the placement of components, CTS configured to enable development of the interconnects between the system clock and cells of the chip(s) employing the system clock, multi-corner/multi-mode optimization configured to account for a number of mode and corner scenarios that have conflicting power, timing, and signal integrity closure requirements, and STA associated with the consolidated design.

Assuming three compile stages associated with the consolidated design and three months time required per compile stage as an example, the total number of man-months required to implement the four IP sub-systems (viz., graphics IP sub-system 302, video IP sub-system 304, audio IP sub-system 306, and DSP IP sub-system 308) as a consolidated design are 6×3×3=54. The 6 refers to the “personnel” resource, the first 3 refers to the number of compile stages, and the second 3 refers to the time required per compile stage.

Thus, there is a drastic reduction in resources required for the IP development associated with the consolidated design. As per the examples/example scenarios described in FIG. 2 and FIG. 5, implementation of the consolidated virtual design merely requires half the number of man-months required to implement the individual IP sub-systems. Consolidated virtual design described above can easily be applied to the development of IPs that are well-known in the art and/or IPs in a mature state (in other words, “mature” IPs, whose development is well enabled by the current state of technology). Concepts involved in the consolidated design/virtual design are employed during technology migration (e.g., upgrade of application processors) and/or during technology revisions with minor changes. As discussed above, the concepts involved herein convenience the fixing of bugs associated with an IP sub-system (e.g., video IP sub-system 304)/IP sub-systems that are part of the consolidated design.

When design changes associated with the one or more IPs in the virtual design are required during implementation/pre-release thereof, the design flow associated with the design changes includes removing the connectivity descriptor(s) (e.g., netlist) associated with the one or more IPs requiring change from the connectivity descriptor(s) associated therewith at the virtual design level. Design changes are applied at the virtual design level at the appropriate design flow stages. When major design changes are required in the one or more IPs at the virtual design level during implementation/pre-release, the appropriate one or more IPs is/are black-boxed from the consolidated design/virtual design level. The black-boxed one or more IPs is re-spun from the appropriate stage(s) of the design flow. Although the re-spun one or more IPs potentially intercepts the consolidated design/virtual design at a later stage (e.g., routing, STA), the appropriate checks detect the potential interception. The re-spun one or more IPs is/are associated with the consolidated design/virtual design following the implementation of the desired changes. The re-spun one or more IPs is also released in a stand-alone form. When design changes are required after release, the corresponding IP(s) alone is/are re-spun.

As seen above, the impact of the combined IP implementation is directly quantifiable. In the example scenarios discussed with regard to FIG. 2 and FIG. 5, the combined IP implementation leads to a 50% decrease in the number of engineers/personnel required. Diverse IPs are part of the consolidated design at the virtual design level. The number of IPs handled by a team is higher when utilizing the combined IP implementation technique. Analogous to the examples discussed with regard to FIG. 3 and FIG. 5, one team is able to handle the implementation of 3-4 IPs at the virtual design level. Decision making associated with more than one SoC is done at the virtual design level. For example, two SoCs within one virtual design (consolidated design) are targeted for decision making.

Assuming the same complexity of IP sub-systems associated with the design of FIG. 1 and the consolidated/virtual design of FIG. 3, the extraction process associated with corner/mode optimization requires the capability of 50 processors (e.g., CPUs) for each IP associated with an IP sub-system of FIG. 1; STA requires the capability of 120 processors for each IP associated with an IP sub-system of FIG. 1; Signal integrity closure requires the capability of 66 processors for each IP associated with an IP sub-system of FIG. 1; Verification processes requires the capability of 15 processors associated with an IP sub-system of FIG. 1. Thus, the total number of processors required for the four IP sub-systems of FIG. 1 is 4×(50+120+66+15)=1004.

In contrast, the extraction process associated with the consolidated/virtual design requires the capability of 100 processors (e.g., CPUs); STA requires the capability of 240 processors. Signal integrity closure requires the capability of 132 processors and verification processes requires the capability of 60 processors. Thus, the total number of processors required for the consolidated system of FIG. 3 is 100+240+132+60=532. The abovementioned example number of processors are arrived at based on the assumption of a 2× run-time associated with the consolidated/virtual design when compared to the design of FIG. 1. Thus, computing resources associated with the consolidated/virtual design is reduced. As per the example discussed above, the computing resources associated with the consolidated design reduce by ˜50% when compared to the computing resources associated with the design of FIG. 1. The consolidated/virtual design allows for better quality/uniformity of deliverables (viz., IPs associated with the IP sub-systems of FIG. 3). Thus, a high standard on quality control of deliverables is maintained.

EDA tools available in the market are not able to handle the complexity associated with the implementation of all of the IP sub-systems of FIG. 1 utilizing the amount of resources associated with the combined implementation of FIG. 3. For example, the gate count associated with an IP design does not exceed an upper limit thereof even with the state-of-the-art physical implementation tools. However, with every revision of EDA tools, the gate count increases, along with several other improvements (e.g., single core implementation to multi-core implementation). The aforementioned improvements are leveraged through the consolidated/virtual design to prospectively increase the gate count associated.

From an architectural perspective, it is not intuitive to place unrelated IPs associated with the IP sub-systems of FIG. 3 together in a consolidated design as the IP sub-systems are not placed together in an SoC context. In the abovementioned example discussed with regard to FIG. 1 and FIG. 2, when there are four teams (one per IP sub-system) for implementation, it is difficult to have a consensus on the methodologies and the best practices employed. Thus, in the abovementioned example discussed with regard to FIGS. 3-5, the consensus on methodologies and the deployment of best practices are eased. For example, if a power optimization technique leads to a 10% power reduction, the technique is deployed easily in a consolidated implementation. In contrast, in the implementation discussed with regard to FIG. 1 and FIG. 2, the power optimization technique needs to be utilized four times.

FIG. 6 illustrates creation of a connectivity descriptor at the virtual design level, according to an embodiment. Entities associated with graphics IP sub-system 302 (e.g., IP1 entity 602), video IP sub-system 304 (e.g., IP2 entity 604), audio IP sub-system 306 (e.g., IP3 entity 606) and DSP IP sub-system 308 (e.g., IP4 entity 608) is mapped to a newly created entity (e.g., VIP entity 610) associated with the virtual design through the appropriate instantiation. Interfaces 310 (e.g., ports) associated with the IP sub-systems (e.g., graphics IP sub-system 302, video IP sub-system 304, audio IP sub-system 306, DSP IP sub-system 308) are specified in the entity declarations thereof. Therefore, interfaces 310 (e.g., ports) associated with the IP sub-systems are also specified in the entity declaration associated with the virtual design. Connectivity descriptors (e.g., netlists) associated with the IP sub-systems (e.g., IP1 netlist 612, IP2 netlist 614, IP3 netlist 616, IP4 netlist 618) are combined through an appropriate command (e.g., a concatenation command) into a connectivity descriptor associated with the virtual design (e.g., VIP netlist 620).

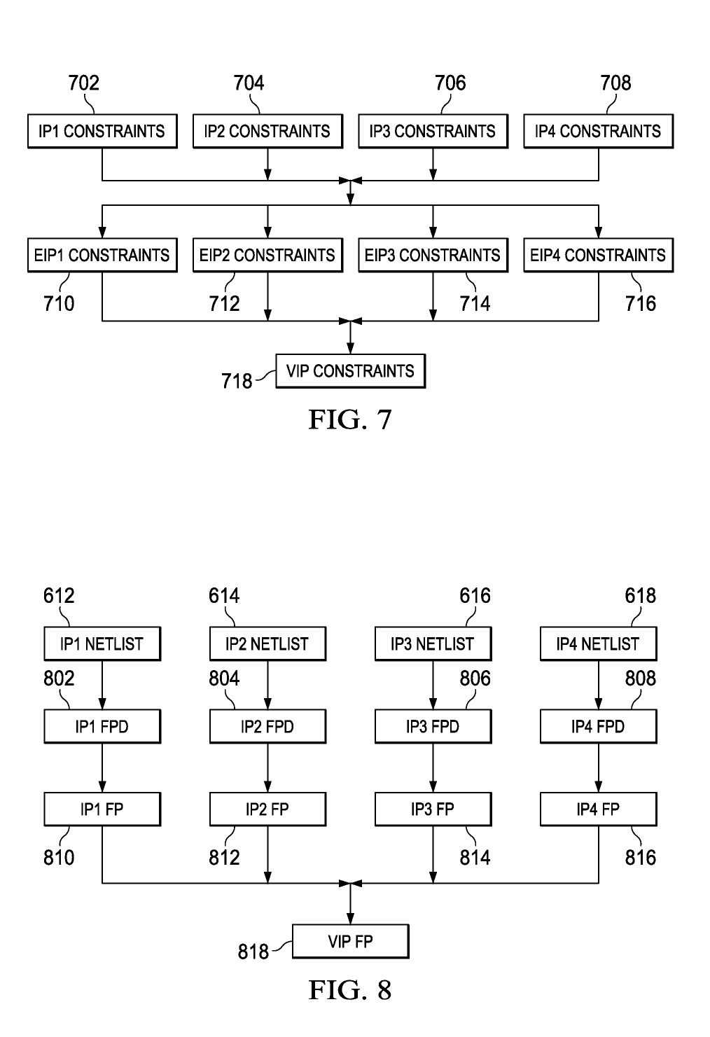

FIG. 7 illustrates inheriting the constraints associated with the IP sub-systems of FIG. 3 at the virtual design level, according an embodiment. The constraints at the individual IP level (e.g., IP1 constraints 702, IP2 constraints 704, IP3 constraints 706, IP4 constraints 708) associated with the IP sub-systems (e.g., graphics IP sub-system 302, video IP sub-system 304, audio IP sub-system 306, DSP IP sub-system 308) of FIG. 3 are ported together as entities (e.g., as EIP1 constraints 710, EIP2 constraints 712, EIP3 constraints 714, EIP4 constraints 716) through an EDA tool being utilized, concatenated and realized as the virtual design level constraints (e.g., as VIP constraints 718). Again, as discussed above, interfaces (e.g., ports) associated with the individual IP sub-systems of the consolidated design of FIG. 3 are retained physically as is therein. Therefore, physical pins associated with the individual IP sub-systems are retained as is in the virtual design. Shapes of the IP sub-systems in the consolidated design are retained as is therein.

In EDA tools handling timing constraints, porting constraints includes interpreting the constraints prior to the inferring thereof at a different hierarchy level. In contrast, in an embodiment, constraints are pushed down a hierarchy level as is such that whatever applies at the individual IP level also applies at the virtual design level. Thus, exact mapping between the constraints at the individual IP level and at the virtual design level is done such that there is no loss thereof between the levels. Even when constraints are closed at the virtual design level, they are not closed at the individual IP level.

The IPs associated with the IP sub-systems of FIG. 3 has different functional modes. Consider an example scenario where the IPs have different modes of closure (e.g., timing closure); the first IP has three functional modes, the second IP has one functional mode, the third IP has two functional modes, and the fourth IP has one functional mode. All the four IPs shares a common functional mode. Further, the first IP and the third IP solely shares another common functional mode. Thus, at the virtual design level, there are three functional modes such that the first functional mode is the common functional mode of the four IPs merged together, the second functional mode is the common functional mode of the first IP and the third IP merged together, and the third functional mode is the functional mode of the first IP that is not common to any other IP. Merging is done through the EDA tool utilized, as discussed above. The functional modes at the individual IP level are thus pushed to a different hierarchy level.

The floor-plan at the virtual design level is obtained from “scratch” or from the reuse of established, mature IPs. FIG. 8 illustrates the creation of a floor-plan at the virtual design level through a “bottom-up” approach, according to an embodiment. The “bottom-up” approach includes leveraging/reusing the IP level floor-plan created at the virtual design level. As illustrated in FIG. 8, connectivity descriptors (e.g., netlists) associated with the IP sub-systems (e.g., IP1 netlist 612, IP2 netlist 614, IP3 netlist 616, IP4 netlist 618), along with the corresponding floor-plan definitions (e.g., IP1 FPD 802, IP2 FPD 804, IP3 FPD 806, IP4 FPD 808), is used to arrive at the floor-plans at the IP level (e.g., IP1 FP 810, IP2 FP 812, IP3 FP 814, IP4 FP 816). The floor-plans at the IP level are combined to create the floor-plan at the virtual design level (VIP FP 818). When a floor-plan update is required at the IP level (i.e., the floor-plan of the IP needs to accommodate a change at any point in time in the flow), the virtual design is committed, the corresponding update to the IP floor-plan (e.g., IP1 FP 810) is done, and the IPs is uncommitted to acquire the changes at the virtual design level.

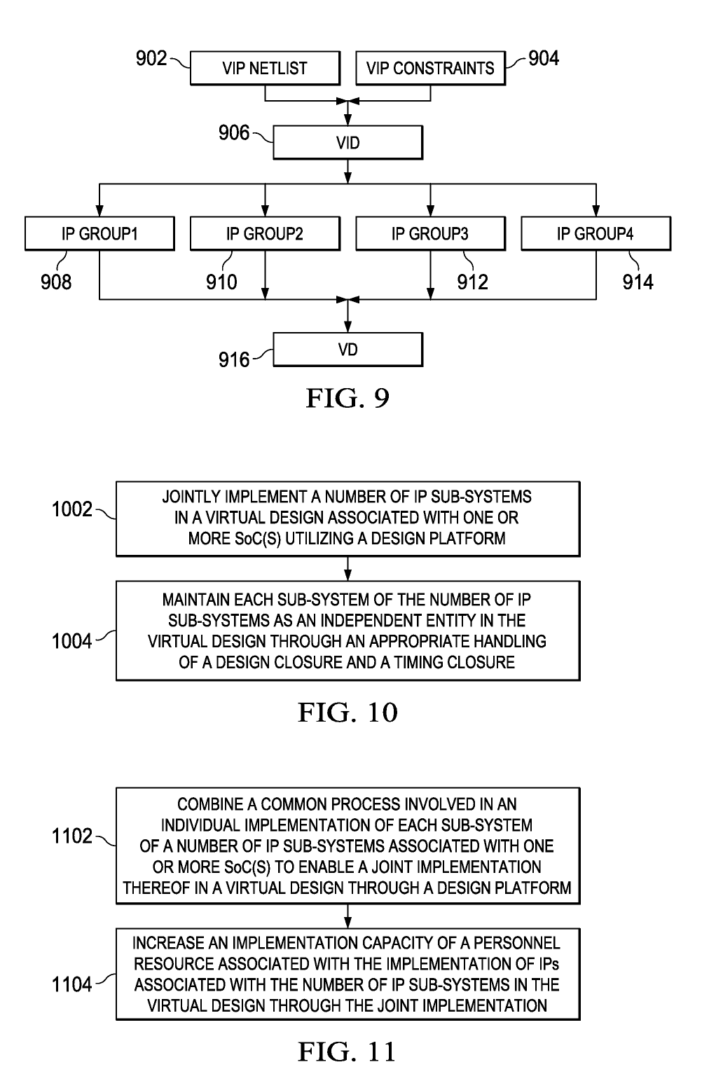

FIG. 9 illustrates the creation of a floor-plan at the virtual design level through a “top-down” approach, according to embodiment. A created virtual design connectivity descriptor (e.g., VIP netlist 902), along with constraints (e.g., VIP constraints 904) associated therewith, is utilized to generate an initial design (e.g., VID 906). Sizes and shapes of constituent IP sub-systems (akin to the IP sub-systems of FIG. 3) also are utilized. A back-up of the initial design (e.g., VID 906) is saved. Each IP to be included (akin to the IP sub-systems of FIG. 3) therein has groups (e.g., IP group 1 908, IP group 2 910, IP group 3 912, IP group 4 914) associated therewith planned for. Floor-plan placement, followed by switch/tap/Electro-Static Design (ESD) cell placement and power routing is then done. Modified initial design finally is saved as the virtual design (VD 916). Thus, the floor-plan at the virtual design level is created from “scratch.”

FIG. 10 illustrates a process flow diagram detailing the operations involved in a method of entitizing the IP sub-systems of FIG. 3 in a joint implementation thereof, according to an embodiment. Operation 1002 involves jointly implementing a number of IP sub-systems (e.g., the IP sub-systems of FIG. 3) in a virtual design associated with one or more SoC(s) utilizing a design platform (e.g., through Synopsys®'s IC compiler, which is part of the Synopsys Galaxy™ design platform). Each sub-system of the number of IP sub-systems is associated with an IP configured to be a deliverable to the one or more SoC(s). Operation 1004 involves maintaining the each sub-system of the number of IP sub-systems as an independent entity in the virtual design through an appropriate handling of a design closure and a timing closure associated therewith.

FIG. 11 illustrates a process flow diagram detailing the operations involved in a method of reducing personnel resources through a joint implementation of a number of IP sub-systems, according to an embodiment. Operation 1102 involves combining a common process involved in an individual implementation of each sub-system of a number of IP sub-systems (e.g., the IP sub-systems of FIG. 3) associated with one or more SoC(s) to enable a joint implementation thereof in a virtual design through a design platform (e.g., through Synopsys®'s IC compiler, which is part of the Synopsys Galaxy™ design platform) utilized therefor. Each sub-system of the number of IP sub-systems is associated with an IP is configured to be a deliverable to the one or more SoC(s). Operation 1104 involves increasing an implementation capacity of personnel resource associated with the implementation of the IPs associated with the number of IP sub-systems through the joint implementation.

It will be appreciated that the various operations, processes, and methods disclosed herein is embodied in a machine-readable medium or a machine accessible medium compatible with a data processing system, and is performed in any order. Accordingly, the specification and drawings are to be regarded in an illustrative rather than a restrictive sense.

What is claimed is:

1. A computer implemented method utilizing a design platform, the method comprising:
jointly implementing a plurality of Intellectual Property (IP) sub-systems in a virtual design associated with at least one System-on-a-Chip (SoC) utilizing a design platform, each sub-system of the plurality of IP sub-systems being associated with an IP configured to be a deliverable to the at least one SoC; and
maintaining each sub-system of the plurality of IP sub-systems as an independent entity in the virtual design through handling a design closure and a timing closure associated with each sub-system,
wherein IPs associated with at least two IP sub-systems of the plurality of IP sub-systems are either related or unrelated to one another.

2. The method of claim 1, wherein jointly implementing the plurality of IP sub-systems in the virtual design comprises at least one of:
combining a common process involved in an individual implementation of the each subsystem of the plurality of IP sub-systems;
utilizing a parallelization ability and a capacity of an Electronic Design Automation (EDA) tool associated with the design platform; and
utilizing a personnel resource to work on at least two IP sub-systems associated with the virtual design.

3. The method of claim 1, further comprising inheriting, at a level of the virtual design, constraints associated with the each sub-system of the plurality of IP sub-systems from an individual IP sub-system level.

4. The method of claim 2, wherein the common process includes at least one of floor-planning, power routing, Design Rule Check (DRC) clean-up of power grid, placement stage optimization of at least one of timing and congestion, timing closure across modes and corners, a reliability check process, and an electrical check process.

5. The method of claim 3, wherein the entitizing of the each sub-system of the plurality of IP sub-systems in the virtual design comprises:
maintaining elements of the each sub-system of the plurality of IP sub-systems in the virtual design to be in spatial correspondence with elements at the individual IP sub-system level;
maintaining an interface between the each sub-system and another sub-system of the plurality of IP sub-systems in the virtual design to be in spatial correspondence with a corresponding interface thereof at the individual IP sub-system level; and
maintaining the interface between the each sub-system and the another sub-system of the plurality of IP sub-systems in the virtual design with respect to logic, physical dimensions and timing budget.

6. The method of claim 5, further comprising eliminating, in the virtual design, an interaction between each sub-system of the plurality of IP sub-systems across the interface.

7. The method of claim 5, further comprising spinning off each sub-system of the plurality of IP sub-systems in the virtual design for re-optimization when goals associated therewith at the individual IP sub-system level are not met.

8. The method of claim 5, further comprising releasing the IP associated with the each sub-system of the plurality of IP sub-systems as a stand-alone deliverable to the at least one SoC.

9. The method of claim 5, further comprising one of:
at least one of leveraging and reusing a floor-plan at the individual IP sub-system level at the level of the virtual design when the IP associated with the each sub-system of the plurality of the IP sub-systems of the virtual design is a mature IP,
wherein the floor-plan at the level of the virtual design is in spatial correspondence with the floor-plan at the individual IP sub-system level; and
creating a floor-plan at the virtual design level from scratch, the floor-plan being configured to include a floor-plan associated with each sub-system of the plurality of the IP sub-systems of the virtual design.

10. The method of claim 8, further comprising:
removing a connectivity descriptor associated with each sub-system of the plurality of IP sub-systems at the level of the virtual design when there is a design change required therein prior to the release of the IP associated with each sub-system; and
applying, at an appropriate design flow stage, the design change in each sub-system of the plurality of IP sub-systems at the level of the virtual design,
wherein when a major design change in the IP associated with each sub-system is required prior to the release thereof, the method further comprises:
black-boxing each sub-system from the virtual design; and
re-spinning the IP associated with the black-boxed each sub-system from an appropriate design flow stage, and
wherein when the design change is required in the IP associated with each sub-system after the release thereof, the method further comprises solely re-spinning the IP associated with each sub-system.

11. A method comprising:
combining a common process involved in an individual implementation of each sub-system of a plurality of IP sub-systems associated with at least one SoC to enable a joint implementation thereof in a virtual design through a design platform utilized therefor, each sub-system of the plurality of IP sub-systems being associated with an IP configured to be a deliverable to the at least one SoC; and
increasing an implementation capacity of personnel resource associated with the implementation of the IPs associated with the plurality of IP sub-systems through the joint implementation thereof,
wherein IPs associated with at least two IP sub-systems of the plurality of IP sub-systems are either related or unrelated to one another.

12. The method of claim 11, further comprising entitizing each sub-system of the plurality of IP sub-systems in the virtual design through an appropriate handling of a design closure and a timing closure associated therewith.

13. The method of claim 12, further comprising:
utilizing a parallelization ability and a capacity of an EDA tool associated with the design platform; and
utilizing the personnel resource to work on at least two IP sub-systems associated with the virtual design.

14. The method of claim 12, further comprising inheriting, at a level of the virtual design, constraints associated with each sub-system of the plurality of IP sub-systems from an individual IP sub-system level thereof.

15. The method of claim 12, wherein the common process includes at least one of floor-planning, power routing, DRC clean-up of power grid, placement stage optimization of at least one of timing and congestion, timing closure across modes and corners, a reliability check process, and an electrical check process.

16. The method of claim 14, wherein the entitizing of each sub-system of the plurality of IP sub-systems in the virtual design includes:
maintaining elements of each sub-system of the plurality of IP sub-systems in the virtual design to be in spatial correspondence with elements at the individual IP sub-system level thereof;
maintaining an interface between each sub-system and another sub-system of the plurality of IP sub-systems in the virtual design to be in spatial correspondence with a corresponding interface thereof at the individual IP sub-system level; and
maintaining the interface between each sub-system and the another sub-system of the plurality of IP sub-systems in the virtual design with respect to logic, physical dimensions and timing budget.

17. The method of claim 16, further comprising eliminating, in the virtual design, a potential interaction between each sub-system and the another sub-system of the plurality of IP sub-systems across the interface therebetween.

18. The method of claim 16, further comprising spinning off each sub-system of the plurality of IP sub-systems in the virtual design for re-optimization when goals associated therewith at the individual IP sub-system level are not met.

19. The method of claim 16, further comprising releasing the IP associated with each sub-system of the plurality of IP sub-systems as a stand-alone deliverable to the at least one SoC.

20. The method of claim 16, further comprising one of:
at least one of leveraging and reusing a floor-plan at the individual IP sub-system level at the level of the virtual design when the IP associated with each sub-system of the plurality of the IP sub-systems of the virtual design is a mature IP,
wherein the floor-plan at the level of the virtual design is in spatial correspondence with the floor-plan at the individual IP sub-system level; and
creating a floor-plan at the virtual design level from scratch, the floor-plan being configured to include a floor-plan associated with each sub-system of the plurality of the IP sub-systems of the virtual design.

21. The method of claim 19, further comprising:
removing a connectivity descriptor associated with each sub-system of the plurality of IP sub-systems at the level of the virtual design when there is a design change required therein prior to the release of the IP associated with each sub-system; and
applying, at an appropriate design flow stage, the design change in each sub-system of the plurality of IP sub-systems at the level of the virtual design,
wherein when a major design change in the IP associated with each sub-system is required prior to the release thereof, the method further comprises:
black-boxing each sub-system from the virtual design; and
re-spinning the IP associated with the black-boxed each sub-system from an appropriate design flow stage, and
wherein when the design change is required in the IP associated with each sub-system after the release thereof, the method further comprises solely re-spinning the IP associated with each sub-system.

22. An SoC comprising:
a plurality of IP sub-systems having IPs associated therewith, at least one IP sub-system of which is jointly implemented in a virtual design along with at least one other IP sub-system through a design platform being utilized,
wherein the at least one IP sub-system is associated with an IP configured to be a deliverable to the SoC,
wherein the at least one other IP sub-system is associated with an IP configured to be a deliverable to one of the SoC and another SoC,
wherein the at least one IP sub-system is entitized at the individual sub-system level in the virtual design through handling a design closure and a timing closure associated therewith, and
wherein the IP associated with the at least one IP sub-system and the IP associated with the at least one other IP sub-system are either related or unrelated to each other.

23. The SoC of claim 22, wherein the common process includes at least one of floor-planning, power routing, DRC clean-up of power grid, placement stage optimization of at least one of timing and congestion, timing closure across modes and corners, a reliability check process, and an electrical check process.
